(19) United States
(12) Patent Application Publication
(10) Pub. No.: US 2026/0121498 A1
(43) Pub. Date: Apr. 30, 2026

(54) ASSEMBLY FOR A RESOLVER AND METHOD FOR PRODUCING A RESOLVER

(71) Applicants: DR. JOHANNES HEIDENHAIN GmbH, Traunreut (DE); LTN Servotechnik GmbH, Otterfing (DE)

(72) Inventors: Nicolai WANGLER, Grassau (DE); Gerhard PIELOK, München (DE); Lutz RISSING, München (DE)

(21) Appl. No.: 19/365,529

(22) Filed: Oct. 22, 2025

(30) Foreign Application Priority Data
Oct. 24, 2024 (EP) 24208738.5

(51) Int. Cl. H02K 24/00; B33Y 10/00; B33Y 40/20; B33Y 80/00; H02K 15/12

(52) U.S. Cl. CPC H02K 24/00; B33Y 80/00; H02K 15/12; B33Y 10/00; B33Y 40/20

(57) ABSTRACT

An assembly for a resolver includes a main body arranged along an axis, multiple laminated core segments and wire windings, and at least one connector coupled to the laminated core segments. The main body is formed in an annular shape and includes receivers arranged along its inner circumference. The laminated core segments are received in the receivers in a form-fitting manner. On the outer circumference of the main body, winding spaces are arranged between the receivers, and the wire windings are at least partially located within the winding spaces.

### CROSS-REFERENCE TO RELATED APPLICATIONS

The present application claims priority to application Ser. No. 24/208,738.5, filed in the European Patent Office on Oct. 24, 2024, which is expressly incorporated herein in its entirety by reference thereto.

### BACKGROUND INFORMATION

In electrical engineering, a resolver is an electromagnetic transducer for converting the angular position of a rotor into an electrical variable or electrical signals. In this regard, the term resolver also includes transducers that are referred to as synchro or rotary transformers or RVDTs (rotary variable differential transformers).

To detect the absolute position, resolvers contain stator windings and rotor windings, for example, which are arranged opposite each other. These wire windings, usually made of copper wire, are wound onto laminated cores formed in one piece, which have cavities for the wire windings. The cavities of the rotor are usually arranged on the outside of the laminated core of the rotor and accordingly can be applied automatically from the outside. In contrast, a problem associated with applying the stator windings is that winding the cavities, which are usually located on the inner circumference, can only be obtained by using complex mechanical winding processes or by hand.

Resolvers of this type are usually produced in large quantities, so the aim is to manufacture the stators and rotors as simply and as automatically as possible.

Japanese Patent Document No. 5-292721 describes a resolver with a stator structure in which the wire windings are applied from the outside. For this purpose, a stator core formed in one piece is first provided with grooves on its outer circumference. After fitting the stator windings into the grooves from the outer circumferential side, a housing ring is mounted onto the stator core from the outside. Finally, the stator core is machined on the inner circumferential side to expose the grooves that were previously introduced.

Such a stator configuration has disadvantages with regard to the rejection rate, since the wire windings can be damaged when the grooves are exposed. In addition, the described configuration of the stator assembly is relatively complex to produce and is also disadvantageous in terms of measuring accuracy.

### SUMMARY

Example embodiments of the present invention provide an assembly for a resolver that can be produced in a comparatively improved automated manner.

According to example embodiments, the assembly for a resolver includes a main body arranged along an axis, multiple laminated core segments and wire windings arranged in the main body and at least one connector coupled to the laminated core segments. The main body is formed in the shape of a ring and has receivers along its inner circumference, in which the laminated core segments are received in a form-fitting manner. On the outer circumference of the main body, axially extending winding spaces are arranged between the receivers, and the winding wires partially extend within the winding spaces.

The form-fitting receiving of the laminated core segments by the receivers of the main body is characterized by a play-free interlocking of the two connecting parts. Relative movements of the laminated core segments are blocked in at least two directions and, for example, are blocked in all directions.

The receivers are arranged at equal distances from each other and extend in an axial direction. The receivers may, for example, be formed by radially arranged rectangular structures that form a cavity for receiving the laminated core segments.

A cavity should be understood to mean, for example, an open cavity, such that the laminated core segments do not necessarily have to be completely surrounded by the enclosing structures of the main body.

The winding spaces are arranged on the outer circumferential side of the main body between the receivers. The winding spaces are arranged as routing channels for the wire windings. For example, the winding spaces may also be formed by the receivers, so that the receivers, on the one hand, provide for receiving the laminated core segments and, on the other hand, are arranged as a winding space boundary for the wire windings arranged therebetween.

According to example embodiments, the assembly is arranged as a stator of the resolver.

According to example embodiments, the main body has, on at least one of its end faces, at least one tab extending in the circumferential direction with a radially oriented and additionally or alternatively with an axially oriented directional component.

The tab may, for example, be formed continuous in the circumferential direction, so that a circumferentially oriented routing channel is formed between the tab and the winding spaces, which also is arranged as a winding space boundary for the sections of the wire windings, which sections extend in the circumferential direction.

Alternatively, multiple tabs may also be provided, which are arranged discontinuously in the circumferential direction.

For example, the main body is formed in multiple pieces or alternatively in one piece and is shaped from a non-magnetic material.

For example, the main body may be formed in two pieces, so that it includes a first main body part and a second main body part, which may be coupled to each other. The coupling point or coupling points are, for example, located along the circumferential direction of the two main body parts.

For example, the non-magnetic material is a formable material without ferromagnetic properties, for example, a chemically or thermally plasticizable plastic or plastic mixtures, synthetic resins, ceramic, glass, etc.

According to example embodiments, the main body is produced by an injection molding process or an additive process, e.g., a 3D printing process.

It is may be provided that the laminated core segments each have a radially inner circumferential section, a radially outer connecting section, and a carrier section arranged therebetween, that the connector has connectors formed complementary to the connecting sections of the laminated core segments, and that the connecting sections of the laminated core segments are joined together with the connectors of at least one connector in an interlocking manner.

The connecting section of the laminated core segments includes, for example, at least one groove, and the connectors of the at least one connector are formed as complementary pins. Alternatively, the connecting sections of the laminated core segments may likewise have complementary pins to the grooves formed on the at least one connector.

For example, the connecting sections of the laminated core segments are connected to the connectors of the connector via one or multiple pin-like connections, for example, in the form of dovetail joints. However, other connecting techniques are also possible, for example, a material-bonding connection via a conductive bonding agent or by welding.

For example, the pin-like connections may have a round contour, which may provide for an improved magnetic conduction behavior between the laminated core segments and the connectors.

For example, the laminated core segments are formed such that the width of the connecting sections is smaller than the width of the circumferential sections.

Such a configuration of the connecting sections provides for an improved transmission of the magnetic flux picked up by the circumferential sections to the connectors.

According to example embodiments, the at least one connector is formed as a laminated core and is arranged either as a ring closed around the circumference or in the form of multiple individual ring segments or ring sectors.

For example, connectors in the form of ring segments may be subsectors of a circular ring, for example, two semicircular rings or multiple subsectors of a circular ring.

The connectors, arranged as semi-circular rings, may be rotationally symmetric over 90° in sections.

For example, each connector, arranged as a partial circular sector, is coupled to the connecting sections of two laminated core segments in the circumferential direction. For example, each of the connectors is coupled to at least two connecting sections that belong to adjacent laminated core segments with respect to the circumferential direction.

For example, the laminated core segments are embedded in the main body so that the circumferential sections and the main body form a substantially flat surface on the inner jacket surface of the assembly and the main body extends to the carrier sections of the laminated core segments.

Flat should be understood in the broader sense, i.e., the inner jacket surface of the assembly, which is curved with a defined radius, is largely flat and without any unevenness when the main body is fully assembled with the laminated core segments. In any case, it should not be understood in this context that the inner jacket surface describes a two-dimensional straight plane.

Consequently, the radius of curvature of the circumferential sections of the laminated core segments is substantially equal to the radius of curvature of the inner jacket surface (webs) of the main body, such that the following relationship is satisfied:

R_{U}=R_{M,I},

in which R_{U} represents the radius of the circumferential sections, and R_{M,i} represents the radius of the outer jacket surface of the main body.

The receivers of the main body are arranged such that the contour of the receivers corresponds to the contour of the carrier sections of the laminated core segments and conforms to this contour over its entire depth. In this section, the receivers of the main body thus act as insulation between the laminated core segments and the wire windings arranged in the region of the carrier sections. The receivers of the main body conform to the outer contour of the laminated core segments, e.g., in the regions of the circumferential sections and the carrier sections. The connecting sections project beyond the receivers and are thus not embedded in the main body.

According to example embodiments, the main body has multiple first tabs and multiple second tabs with a radial directional component, and the first and second tabs are arranged in an alternating manner along the circumferential direction.

According to example embodiments, a method for producing a resolver, which has two assemblies rotatable relative to each other about an axis, includes, for producing at least one of the assemblies: at least partial embedding laminated core segments in a main body formed by an injection molding process or additive process; applying wire windings to the outer circumference of the main body in winding spaces formed between the laminated core segments; and joining the exposed sections of the laminated core segments with at least one connector.

For example, the wire windings are applied to the outer circumference of the main body from the outside via an automated winding technique, for example, via a flyer winding technique, a needle winding technique, a linear winding technique, etc. For example, the wire windings sometimes extend over more than one laminated core segment with respect to the circumferential direction.

According to example embodiments, the laminated core segments are embedded by inserting the laminated core segments into the receivers of the main body.

The individual laminated core segments may, for example, be inserted radially or axially into the receivers of the main body by pushing or pressing them in. Due to the form-fitting configuration of the receivers, the laminated cores remain in the cavities, held by the receivers. This means that the producing of the main body and the embedding of the laminated core segments take place in two separate steps.

In addition, it may be provided that a material bonding agent, for example, an adhesive, is applied to the receivers before the laminated core segments are inserted in order to fasten the laminated core segments in a non-detachable manner.

According to example embodiments, the laminated core segments are embedded by forming the main body via overmolding the laminated core segments.

This means that the producing of the main body and the embedding of the laminated core segments take place in the same step.

If the main body is produced using an injection molding process, for example, the individual laminated core segments are inserted into the injection mold and the flowable material is then injected.

Alternatively, if the main body is produced using an additive process, the laminated core segments—after the initial layers have been produced on a substrate—are placed on the precursor of the main body and the overmolding of the laminated core segments is continued by stacking layers until the main body is fully formed.

For example, the wire windings are applied radially from the outside and along the outer circumference of the assembly.

When applying the wire windings, the winding wire is inserted into the winding spaces arranged on the outer circumference of the assembly to be wound, for example, a stator, using the flyer winding technique (also referred to as flying wire). The winding wire is fed via a roller or through a nozzle attached to a flyer, i.e. a rotating disk, which is rotated at a defined distance from the assembly. The winding wire is wound in a defined manner around at least one laminated core segment insulated by the receivers. The flyer is, for example, movable relative to the assembly in the circumferential direction and in the radial direction.

Applying the wire windings starting from the inner circumference of the assembly is thus not intended. This applies both in the case where the assembly is arranged as a rotor and in the case where the assembly is arranged as a stator.

Further features and aspects of example embodiments of the present invention are described in more detail below with reference to the appended schematic Figures.

### BRIEF DESCRIPTION OF THE DRAWINGS

FIG. 1 illustrates a resolver with a stator and a rotor.

FIG. 2 is an exploded view of a resolver assembly.

FIG. 3 is a perspective view of a first main body part of the resolver.

FIG. 4 is a perspective view of a second main body part of the resolver.

FIG. 5 is a front view of a laminated core segment.

FIG. 6 is a front view of a connector.

FIG. 7 illustrates the process of joining a resolver module.

FIG. 8 further illustrates the process of joining the resolver assembly.

FIG. 9 further illustrates the process of joining the resolver assembly.

FIG. 10 is a cross-sectional view of an assembly of the resolver.

### DETAILED DESCRIPTION

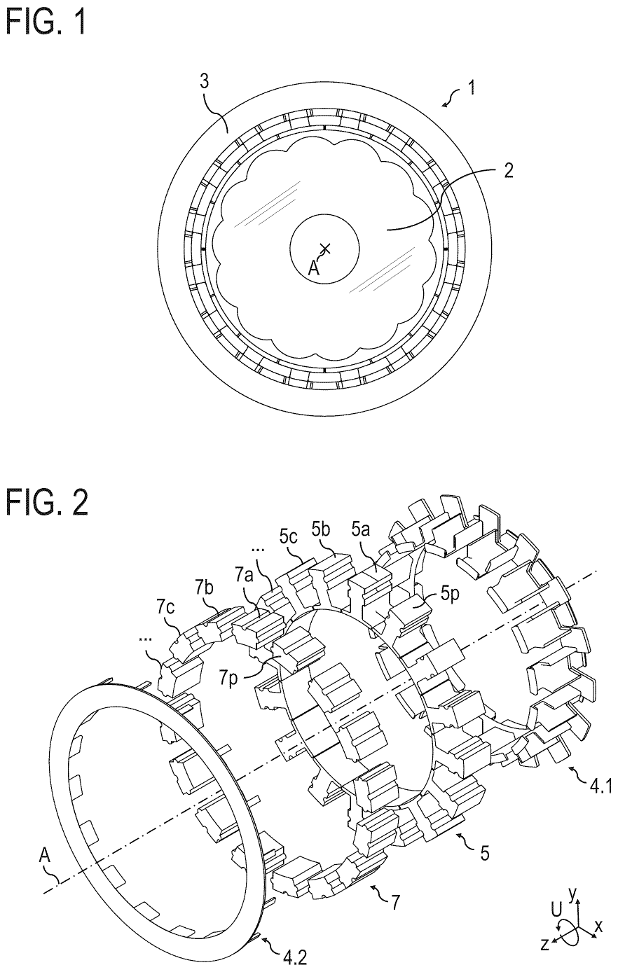

FIG. 1 illustrates a resolver 1 that includes a stator 3 and a rotor 2 arranged concentrically to an axis A. In the resolver 1, the stator 3 is formed in multiple parts so that external winding is possible during its production, as discussed in more detail below. Rotor 2 is formed, for example, as a rotor core with a variable contour. However, instead of the rotor type illustrated in FIG. 1, other rotor types are also possible, for example, of the winding field type, in which exciter windings are arranged on the rotor 2. FIG. 2 is an exploded view of a stator 3 arranged along the axis A. The stator 3 includes a main body 4.1, 4.2 formed in multiple pieces, a laminated core segment assembly 5, a connector assembly 7, and wire windings 6.

The main body includes, or consists of, a first main body part 4.1 and a second main body part 4.2, which can be coupled together.

The laminated core segment assembly 5 includes multiple laminated core segments 5a to 5p, which are arranged concentrically around the axis A and at the same distance from the axis A.

For clarity, not every laminated core segment illustrated in FIG. 2 has its own reference number. However, it should be understood that the alphanumeric reference numbers are logically continued in the circumferential direction U for each further laminated core segment.

According to the illustrated example embodiment, the connector assembly 7 includes multiple connectors 7a to 7p, which are arranged concentrically around the axis A and at the same distance from the axis A.

For clarity, not every connector illustrated in FIG. 2 has its own reference number. However, it should be understood that likewise the alphanumeric reference numbers are logically continued in the circumferential direction U for each further connector.

The stator is not limited to sixteen laminated core segments 5a to 5p or sixteen connectors 7a to 7p as illustrated in FIG. 2. That is, more or fewer laminated core segments or connectors may also be provided. For example, the number of connectors does not necessarily have to correspond to the number of laminated core segments.

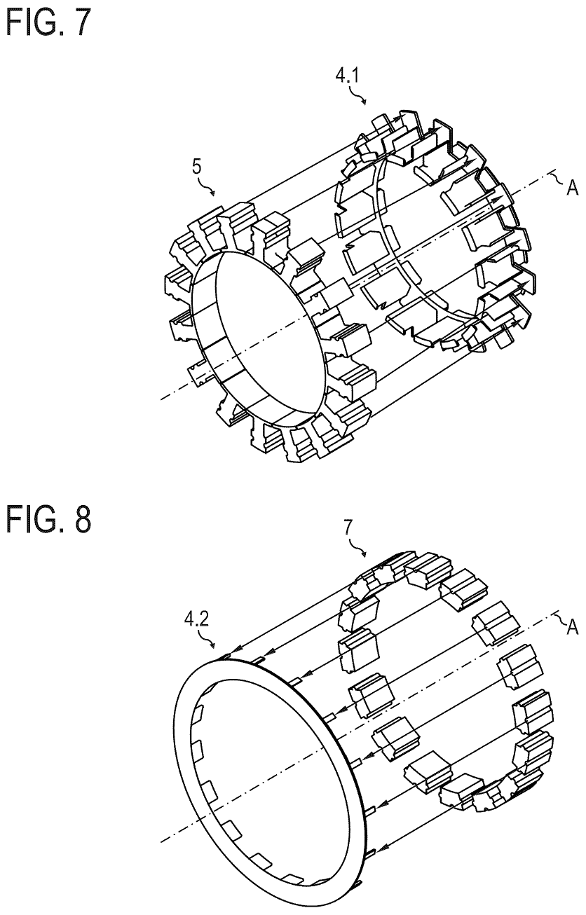

The individual assemblies of the stator 3 are coupled together in the assembled state, which is described in more detail below with reference to FIGS. 7 to 9 as part of the production process.

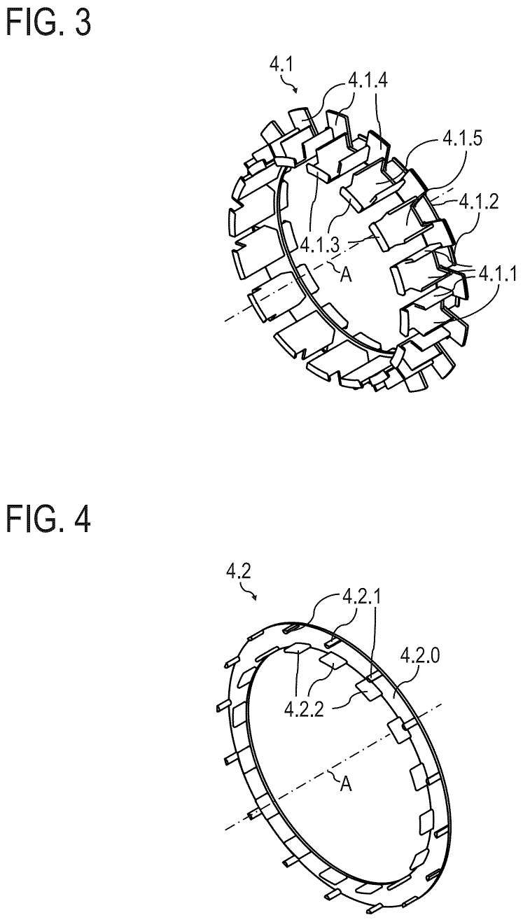

The configuration of the main body, including the first and second main body parts 4.1, 4.2, is illustrated in FIGS. 3 and 4.

The first main body part 4.1 is arranged as an annular injection-molded part and includes multiple axially extending rectangular receivers 4.1.1, which extend at a distance around the entire circumference of the first main body part. Two directly adjacent receivers 4.1.1 are connected to each other in an approximate U-shape via a web 4.1.5 extending in the circumferential direction U, so that a winding space 8 (see, e.g., FIG. 10) is formed between them.

The webs 4.1.5 project at both ends in the axial direction beyond the receivers 4.1.1 and have a radially oriented second tab 4.1.2 at one end and a radially oriented further second tab 4.1.3 at the other end. The two second tabs 4.1.2, 4.1.3 are arranged as winding space boundaries or, in combination with the projecting sections of the webs 4.1.5, as routing channels for those sections of the wire windings 6 that are oriented in the circumferential direction U.

It is provided that a first tab 4.1.4 is provided between two adjacent receivers 4.1.1 that are not connected by a web 4.1.5. The first tab 4.1.4 is rectangular and extends perpendicular to the receivers 4.1.1 and in the circumferential direction U. The first tabs 4.1.4, for example, project beyond the receivers 4.1.1 in the radial direction. In addition, the first tabs 4.1.4 extend in the circumferential direction U only over that region which lies between the two adjacent receivers 4.1.1 that are not connected by a web 4.1.5.

The radial direction refers to a direction that points outwardly from the axis A (center point).

The receivers 4.1.1, the webs 4.1.5, the first tabs 4.1.4, and the second tabs 4.1.2 and 4.2.3 are all formed together so that they jointly form the one-piece first main body part 4.1.

FIG. 4 illustrates the second main body part 4.2, which is also formed as an annular injection-molded part and includes a first tab closed in the circumferential direction U in the form of an annular disc 4.2.0. Multiple second tabs 4.2.2, which are rectangular, are arranged on one of the end faces of the annular disk 4.2.0 and radially on the inside. The second tabs 4.2.2 protrude perpendicular to the end face of the annular disk 4.2.0 in the axial direction and are arranged at a distance from each other in the circumferential direction U.

The second main body part 4.2 additionally includes further second tabs in the form of alignment pins 4.2.1, which are arranged in the axial direction and perpendicular to the end face on which the second tabs 4.2.2 are also located. The alignment pins 4.2.1 are arranged radially outwardly on the end face of the annular disk 4.2.0. For example, each alignment pin 4.2.1 is arranged opposite a respective second tab 4.2.2 and is centered with respect thereto in the circumferential direction. In addition to the semicircular cross-section illustrated in FIG. 4, the centering pins 4.2.1 may also have any other cross-sectional geometry that is complementary to the recess 7.3 of a connector 7a to 7p.

The annular disk 4.2.0, the second tabs 4.2.2, and the centering pins 4.2.1 are all formed together so that they jointly form the one-piece second main body part 4.2.

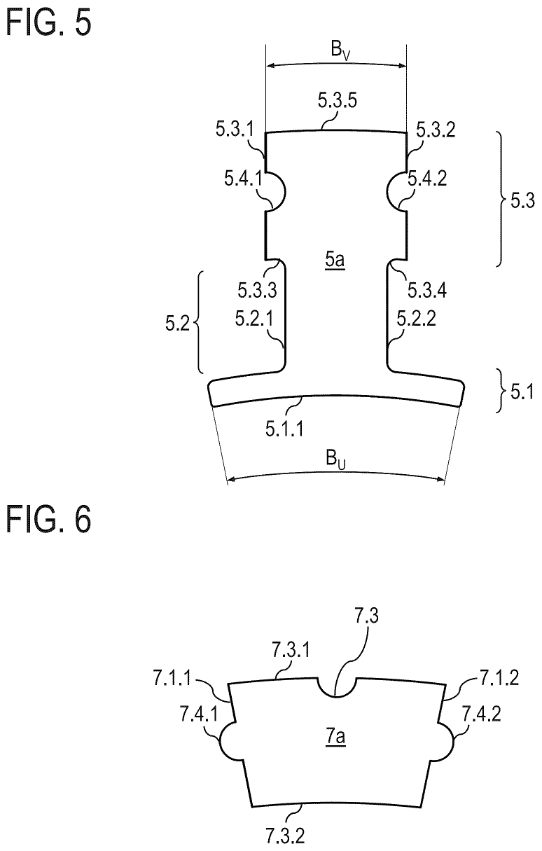

The configuration of a laminated core segment is explained in more detail below with reference to the laminated core segment 5a illustrated in FIG. 5, and the other laminated core segments 5b to 5p are formed identically.

The T-shaped laminated core segment 5a includes a circumferential section 5.1, a connecting section 5.3, and a carrier section 5.2 arranged between the circumferential section 5.1 and the connecting section 5.3.

The carrier section 5.2 is oriented in a radial direction and has an approximately rectangular cross-section. The carrier section 5.2 has a first side 5.2.1 and a second side 5.2.2, which are in contact with the corresponding receiving sections 4.1.1 after the laminated core segment 5a has been embedded in the main body 4.1, 4.2.

The connecting section 5.3 is arranged on carrier section 5.2 and is located radially on the outside with respect to the axis A. The connecting section 5.3 has a first side 5.3.1 and a second side 5.3.2, each of which is arranged as a contact surface for a connectors 7a to 7p. The first and second sides 5.3.1, 5.3.2 of the connecting section 5.3 respectively have a groove 5.4.1, 5.4.2, formed complementary to the pin or pins 7.1 of the corresponding devices 7a to 7p. The transition 5.3.3 between the first side 5.2.1 of the carrier section 5.2 and the first side 5.3.1 of the connecting section 5.3 is formed continuously and includes a defined curvature. The same applies to the transition 5.3.4 between the second side 5.2.2 of the carrier section 5.2 and the second side 5.3.2 of the connecting section 5.3, which also includes a defined curvature. The connecting section 5.3 also has a second side surface 5.3.5, which is arranged between the first and second sides 5.3.1, 5.3.2. The second side surface 5.3.5 forms a partial surface of the outer jacket surface of the stator 2 and is formed curved in the circumferential direction U.

As illustrated in FIG. 5, the connecting section 5.3 is wider in the circumferential direction U than the carrier section 5.2, i.e., the connecting section 5.3 projects beyond the carrier section 5.2.

In FIG. 5, the width of the connecting section 5.3 in the circumferential direction U is designated by reference character B_{V}.

In addition, the circumferential section 5.1 is arranged on the carrier section 5.2. The circumferential section 5.1 is curved along the circumferential direction U and projects both beyond the first and second sides 5.2.2, 5.2.2 of the carrier section 5.2 and beyond the first and second sides 5.3.1, 5.3.2 of the connecting section 5.3. The circumferential section 5.1 is arranged in the radial direction on the connecting section 5.3 and lies closer to the axis A than the connecting section 5.3 or the carrier section 5.2. The circumferential section 5.1 has a first side surface 5.1.1, which forms a partial surface of the inner jacket surface of the stator 2. The first side surface 5.1.1 is curved in the circumferential direction U.

In FIG. 5, the width of the circumferential section 5.1 in the circumferential direction U is designated by reference character B_{U}.

As illustrated in FIG. 5, the width B_{V} of the connecting section 5.3 is smaller than the width B_{U} of the circumferential section 5.1. Such an arrangement of the connecting section 5.3 provides for an improved transmission of the magnetic flux picked up by the circumferential section 5.1 to the connectors 7a to 7p.

The laminated core segment 5a includes, or consists of, multiple individual laminations, which are stacked in the direction of the drawing plane in FIG. 5 (i.e., in the z-direction in FIG. 1). The individual laminations of the laminated core segment 5a are punched from a soft magnetic sheet and may have a thickness between 0.1 mm and 1.0 mm. The configuration of a connector 7a is explained in more detail below with reference to the connector 7a illustrated in FIG. 6, it being understood that the other connectors 7b to 7p are formed identically.

The connector 7a is formed as a ring sector with respect to its basic shape and includes a radial first side 7.1.1, a radial second side 7.1.2, a first side surface 7.3.1 curved in the circumferential direction U, and a second side surface 7.3.2 curved in the circumferential direction U.

The first and second sides 7.1.1, 7.1.2 are arranged as contact surfaces for a connecting section 5.3 of a laminated core segment 5a to 5p. For this purpose, the first and second sides 7.1.1 and 7.1.2 respectively have one (or multiple) pin(s) or projections 7.4.1, 7.4.2 formed complementary corresponding to the grooves 5.4.1, 5.4.2 of the laminated core segment 5a. The first side surface 7.3.1 and the second side surface 7.3.2 are arranged between the first and second sides 7.1.1, 7.1.2.

The first side surface 7.3.1 includes a recess 7.3 configured to receive an alignment pin 4.2.1 of the second main body part 4.2 (see, e.g., FIGS. 8 and 10).

The second side surface 7.3.2 is located further inwardly than the first side surface 7.3.1 with respect to the axis A in the radial direction.

The connector 7a includes, or consists of, multiple individual laminations, which are stacked in the direction of the drawing plane in FIG. 6 (i.e., in the z-direction in FIG. 1). The individual laminations of the connector 7a are punched from a soft magnetic sheet and may have a thickness between 0.1 mm and 1.0 mm.

The method for producing the stator 3 is be described in more detail below with reference to FIGS. 7 to 9.

As illustrated in FIG. 7, the laminated core segment assembly 5 is first embedded in the first main body part 4.1 by inserting the individual laminated core segments 5a to 5p. For this purpose, the individual laminated core segments 5a to 5p are inserted such that they are received by the receivers 4.1.1 in a form-locking, and, for example, also in a force-locking manner, and are secured against slipping. The individual laminated core segments 5a to 5p contact two adjacent receivers 4.1.1 in the region of their carrier section 5.2, i.e., by at least partial contact with the first and second sides 5.2.1, 5.2.2. The individual laminated core segments 5a to 5p are inserted in the axial direction until they rest against the first tab 4.1.4 of the first main body part 4.1.

Due to the receivers 4.1.1 of the first main body part 4.1, the individual laminated core segments 5a to 5p are arranged at a defined distance from each other in the region of the circumferential sections 5.1, i.e., there is a gap between the circumferential sections 5.1 of the individual laminated core segments 5a to 5p in the form of an air gap. This ensures that, during operation of the resolver 1, the magnetic resistance between a laminated core segment 5a via the at least one connector 7a to 7p to an adjacent laminated core segment 5b or 5p is lower than via the direct path, i.e., via the gap between the laminated core segments 5a and 5b or 5a and 5p in the region of the circumferential sections 5.1. The same applies to all other laminated core segments 5a to 5p in relation to each other. In other words, the air gap ensures that the magnetic field lines conducted through the laminated core segments 5a to 5p close via the connectors 7a to 7p and do not take a shortcut from pole to pole in the region of the circumferential sections 5.1.

After combining the laminated core segment assembly 5 with the first main body part 4.1, the windings 6 can be applied using a suitable winding technique, which is, for example, performed automatically. For example, the individual windings 6 are wound onto the receivers 4.1.1 and first tabs 4.1.4 in the region of the individual carrier sections 5.2.

The configuration of the laminated core segments 5a to 5p and their arrangement to form a laminated core segment assembly 5 in combination with the first main body part 4.1 provides winding from the outside, i.e., the individual winding spaces 8 are filled radially from the outside (outer jacket surface of the assembly) and not via the inner circumference (inner jacket surface of the assembly) as is otherwise usual with stators.

As illustrated in FIG. 8, the connector assembly 7 is embedded in the second main body part 4.2 by inserting the individual connectors 7a to 7p. For this purpose, the individual connectors 7a to 7p are respectively inserted into the cavity between a second tab 4.2.2 and an opposing centering pin 4.2.1. Each connector 7a to 7p thus rests against a second tab 4.2.2 with its second side surface 7.3.2 and is oriented and secured against slipping by a centering pin 4.2.1 received in the recess 7.3. The individual connectors 7a to 7p are respectively inserted in the axial direction until they rest against the annular disk 4.2.0 of the second main body part 4.2.

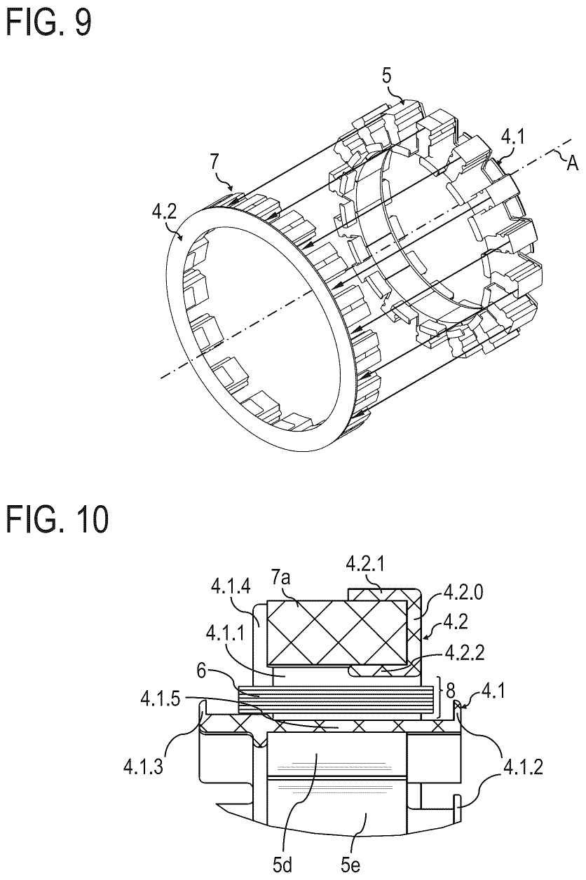

FIG. 9 illustrates the insertion of the first combined assembly, which includes the first main body part 4.1 and the laminated core segment assembly 5, into the second combined assembly, which includes the second main body part 4.2 and the connector assembly 7.

During the insertion process, as illustrated in FIG. 9, the connecting sections 5.3 of the laminated core segments 5a to 5p are combined with the connectors 7a to 7p so that the pins 7.4.1, 7.4.2 of the connectors 7s to 7p and the grooves 5.4.1, 5.4.2 of the laminated core segments 5a to 5p interlock, for example, via a press fit.

FIG. 10 is a cross-sectional view through the stator 3 including the windings 6, which are arranged in the winding space 8. The winding space 8 is bounded in the axial direction by the second tabs 4.1.2, 4.1.3 of the first main body part 4.1 and in the radial direction by the web 4.1.5 and the second tab 4.2.2 of the second main body part 4.2.

According to example embodiments, it is possible for the assembly 2, 3 to be a rotor 2 of the winding field type in addition to a stator 3. In this case, the laminated core segments 5a to 5p are arranged inverted in the radial direction, i.e., the circumferential sections 5.1 are located radially on the outside with respect to axis A and the connecting sections 5.3 are located radially on the inside. The circumferential sections 5.1 of the laminated core segments 5a to 5p are curved in the circumferential direction U and form the outer circumference of the rotor 2. The connecting sections 5.3 and the at least one device 7a to 7p are located on the inner circumference of the annular rotor 2.

### LIST OF REFERENCE CHARACTERS

1 Resolver
2 Rotor
3 Stator
4 Main body
4.1 First main body part
4.1.1 Receiver of the first main body part
4.1.2 Second tab of the first main body part
4.1.3 Further tab of the first main body part
4.1.4 First tab of the first main body part
4.1.5 Web of the first main body part
4.2 Second main body part
4.2.0 Annular disk of the second main body part
4.2.1 Alignment pin of the second main body part
4.2.2 Second tab of the second main body part
5 Laminated core segment assembly
5a to 5p Laminated core segment
5.1 Circumferential section of a laminated core segment
5.1.1 First side surface of the laminated core segment
5.2 Carrier section of a laminated core segment
5.2.1 First side of the carrier section
5.2.2 Second side of the carrier section
5.3 Connecting section of a laminated core segment
5.3.1 First side of the connection section
5.3.2 Second side of the connecting section
5.3.3 First transition
5.3.4 Second transition
5.3.5 Second side surface of the laminated core segment
6 Wire windings
7 Connector assembly
7a to 7p Connector
7.1.1 First side of the connector
7.1.2 Second side of the connector
7.3 Recess of the connector
7.3.1 First side surface of the connector
7.3.2 Second side surface of the connector
7.4.1 First pin of the connector
7.4.2 Second pin of the connector
8 Winding space
A Axis
U Circumferential direction
B_{V} Width of a connecting section
B_{U} Width of a circumferential section
R_{U} Radius of the circumferential sections
R_{M,i} Radius of the outer jacket surface of the main body

What is claimed is:

1. An assembly for a resolver, comprising:
an annular main body arranged along an axis and including receivers arranged along an inner circumference of the main body and winding spaces arranged on an outer circumference of the main body between the receivers;
a plurality of laminated core segments and wire windings, the laminated core segments being received in the receivers in a form-fitting manner, the wire windings being at least partially arranged in the winding spaces; and
at least one connector coupled to the laminated core segments.

2. The assembly according to claim 1, wherein the assembly is arranged as a stator of the resolver.

3. The assembly according to claim 1, wherein the main body includes an end face and at least one tab arranged on the end face, the tab extending in a circumferential direction with a radially and/or axially oriented directional component.

4. The assembly according to claim 1, wherein the main body includes multiple pieces.

5. The assembly according to claim 1, wherein the main body is formed of a non-magnetic material.

6. The assembly according to claim 1, wherein the main body is arranged as an injection molded component and/or as a component formed by an additive process.

7. The assembly according to claim 1, wherein each laminated core segment includes a radially inner circumferential section, a radially outer connection section, and a carrier section arranged between the circumferential section and the connection section, the connector including connection sections complementary to the connection sections of the laminated core segments, and the connection sections of the laminated core segments are joined together with the connection sections of the connectors in an interlocking manner.

8. The assembly according to claim 7, wherein a width of the connection section of the laminated core segment is smaller than a width of the circumferential sections.

9. The assembly according to claim 7, wherein the connector is arranged as a laminated core and (a) is arranged a ring closed around a circumference or (b) includes multiple ring segments.

10. The assembly according to claim 9, wherein each ring segment is coupled in a circumferential direction to two connection portions of the laminated core segments.

11. The assembly according to claim 7, wherein the laminated core segments are embedded in the main body so that the circumferential sections and the main body form a flat surface and the main body extends to the carrier sections of the laminated core segments.

12. The assembly according to claim 3, wherein the main body includes a plurality of first tabs and a plurality of second tabs having a radial directional component, the first tabs and the second tabs being arranged in an alternating manner along the circumferential direction.

13. The assembly according to claim 1, wherein the connector includes a plurality of stacked laminations.

14. The assembly according to claim 13, wherein each lamination is arranged as a punch soft magnetic sheet.

15. The assembly according to claim 1, wherein each laminated core segment includes a plurality of stacked laminations.

16. The assembly according to claim 15, wherein each lamination is arranged as a punch soft magnetic sheet.

17. A method of producing a resolver that includes two assemblies that are rotatable about an axis, the method comprising producing at least one of the assemblies by:
at least partial embedding laminated core segments in a main body that is formed by an injection molding process and/or an additive process;
applying wire windings to an outer circumference of the main body in winding spaces formed between the laminated core segments; and
joining exposed sections of the laminated core segments with at least one connector.

18. The method according to claim 17, wherein the embedding of the laminated core segments includes inserting the laminated core segments into receivers of the main body.

19. The method according to claim 17, wherein the embedding of the laminated core segments includes forming the main body by overmolding the laminated core segments.

20. The method according to claim 17, wherein the application of the wire windings is performed radially from an outside and along an outer circumference of the assembly.
